(19) United States
(12) Patent Application Publication
(10) Pub. No.: US 2026/0275538 A1
(43) Pub. Date: Sep. 17, 2026

(54) REDOX MEDIATED ELECTROCHEMICAL REACTION OF A GAS

(71) Applicant: Schlumberger Technology Corporation, Sugar Land, TX (US)

(72) Inventor: Debora Campos de Faria, Cambridge (GB)

(21) Appl. No.: 19/561,658

(22) Filed: Mar. 10, 2026

(30) Foreign Application Priority Data
Mar. 12, 2025 (GB) 2503671.6

(51) Int. Cl. C25B 9/15; C25B 1/01; C25B 1/23; C25B 1/27; C25B 3/26; C25B 11/037; C25B 15/08

(52) U.S. Cl. CPC C25B 9/15; C25B 1/01; C25B 1/23; C25B 1/27; C25B 3/26; C25B 11/037; C25B 15/087

(57) ABSTRACT

In an electrochemical system, a liquid is circulated from a half-cell to a reaction vessel and then returned to the half-cell. A redox mediator in the liquid is converted from a first state to a second state in the half-cell and reacts with a gas in the reaction chamber while being returned to its first state. The circulating liquid also contains a high molecular weight linear polymer or a viscoelastic surfactant which forms wormlike micelles enabling it to be in a state of elastic turbulence and the reaction chamber is configured to compel changes of flow direction so that the liquid is in a state of elastic turbulence as it flows through the reaction chamber.

### CROSS REFERENCE TO RELATED APPLICATIONS

This application claims priority to GB Patent Application No.: 2503671.6, which was filed on Mar. 12, 2025, and is incorporated herein by reference in its entirety.

### FIELD

This disclosure relates to electrochemical reaction in which a starting material is a gas and the electrochemical reaction is brought about using a redox mediator.

### BACKGROUND

One approach for bringing about electrochemical reactions is that a starting material for a reaction is supplied to a reaction chamber which is part of a flow circuit which also includes an electrochemical half-cell. Liquid in this flow circuit provides the electrolyte liquid for the half-cell. A substance, termed a redox mediator, which is in solution in the liquid undergoes an electrochemical reaction and is then transported from the half-cell to the reaction chamber where it undergoes chemical reaction with the starting material. Use of a redox mediator can be useful to keep the starting material or the products of reaction away from the electrode in the half-cell. In some instances, the desired reaction of the starting material cannot be made to happen at the electrode in the half-cell but can be brought about using a redox mediator.

The efficiency of electrochemical systems can be quantified as a ratio of electric current to dimensions or weight of the apparatus. More specifically, current density, which is the ratio of electrical current to the area within an outline of the electrode is a measure of efficiency of an electrochemical half-cell.

The potential required to bring about an electrochemical reaction normally consists of a thermodynamically determined potential, which is dependent on the reaction concerned, the material of the electrode and concentrations of reactants and products, plus an additional potential, referred to as overpotential. Overpotential reduces the efficiency of an electrochemical reaction. It may have a number of sources, but includes potential required for attracting reactive species from bulk solution to an electrode surface.

Electrodes are frequently formed of a porous or otherwise structured material to enhance the surface area within the electrode outline available for contact with liquid. A porous structure can also be used to support a catalyst. Designs which use a high surface area porous material can be classified as either “flow through” type in which there is an inlet to the porous material in one place and an outlet from it in another place or “flow-past” type in which the fluid flows across an outer surface of a body of porous material (which may be a thin body) and at least some of the fluid flow diffuses into the porous matrix. A flow-past design may have the advantage of a relatively low resistance to flow, with a largely even distribution of fluid when it is delivered to the porous electrode. However, this comes at the cost of relying on diffusive transport in the direction perpendicular to the channel, and within the porous electrode to facilitate the movement of electroactive species from the channel, to and from the electrode. Electrodes which are entirely flow-through or entirely flow-past represent extremes. There are many flow field designs which are in between.

### SUMMARY

This summary is provided to introduce concepts that will be further elaborated and described below in the detailed description. This summary is not intended to be used as an aid in limiting the scope of the claimed subject matter.

The present disclosure uses the phenomenon of elastic turbulence. It is a physical phenomenon discovered at the end of the twentieth century. It occurs at low flow speeds where a Newtonian liquid such as pure water would be in a state of laminar flow.

The present disclosure uses the phenomenon of elastic turbulence in a reaction chamber where a starting material is supplied to the reaction chamber as a gas and reacts with a redox mediator. In a first aspect the present disclosure provides a system comprising a reaction chamber, means for supplying a reactant gas to the reaction chamber, an electrochemical cell comprising first and second half-cells each comprising an electrode, at least one pump, and connections between the pump, the reaction chamber and the first half-cell providing a first flow circuit for the pump to circulate a liquid through the reaction chamber, from the reaction chamber to the first half-cell, through the first half-cell and back to the reaction chamber, wherein: the first half-cell defines a flow path to carry flow of the liquid into contact with the electrode, the reaction chamber defines flow paths to carry flow of the liquid and flow of the gas into contact with each other in the reaction chamber, an electrochemically reactive mediator substance is dissolved in the liquid and the mediator substance is such that when electric current is supplied to the electrode while the pump is circulating the liquid, the mediator substance is converted from a first state to a second state at the electrode, the gas is able to undergo a reaction with the mediator substance in the reaction chamber which converts the gas to a reaction product and returns the mediator substance to the first state thereof, and further wherein: the liquid further includes a solute enabling the liquid to display elastic turbulence, and the flow path in the reaction chamber is configured to compel changes in the direction of liquid flow, to cause elastic turbulence of the flow of the liquid in the reaction chamber.

In another aspect the present disclosure provides a process for conversion of a gas to another substance comprising operating a system as stated above, by pumping the liquid around the flow circuit, supplying the gas to an inlet of the reaction chamber and applying electrical potential to the electrodes.

One way to configure the flow path to compel changes in the direction of flow of liquid is for the flow path to extend through a bed of particulate material. Another is for the flow path to be defined by a guide which is made of a solid material and includes obstructions which compel changes in the direction of liquid flow.

Turbulence in a reaction chamber will enhance mixing of the incoming gas and the redox mediator. Elastic turbulence is advantageous in that it requires much lower speed of flow than inertial turbulence and so the energy needed for pumping is less than with inertial turbulence. Moreover, elastic turbulence may be possible in circumstances where resistance to flow would make inertial turbulence unachievable. The lower speed of flow required by elastic turbulence may be helpful in giving longer residence times within a reaction chamber which may lead to more complete reaction.

Some reactions of a gas with a redox mediator will require a reaction catalyst which is a solid material on a support within the reaction chamber. Elastic turbulence will then improve mass transport of the redox mediator and the gas to the catalyst surface which may enhance reaction rate at the catalyst and provide more complete reaction of the redox mediator at the catalyst.

The system may be constructed such that elastic turbulence is made to occur both in the reaction chamber and also in the half-cell. Elastic turbulence in the half-cell may improve mass transport of the redox mediator to and from the electrode, which may reduce overpotential.

The thermodynamically determined potential for reaction of a redox mediator in a half-cell is dependent on the redox mediator and also on the material of the electrode, the product formed and the concentrations of the first and second states of the redox mediator. Thermodynamically determined potential E is given by the Nernst equation which, in a simplified form, can be written as:

$$E = {E}_{0} - \frac{RT {\sum }_{i} ln [ {P}_{i} ]}{zF {\sum }_{i} ln [ {S}_{i} ]}$$

where E₀ is a standard potential, [P] is the concentration of a product (here the concentration of a redox mediator in its second state, [S] is the concentration of a starting reactant (here the concentration of the redox mediator in its first state, Ris the gas constant, Tis temperature, Fis Faraday's constant and z is the number of electrons transferred in the reaction. Since redox potential is affected by concentrations of reactants and products it may be desirable that a redox mediator is fully, or nearly fully, converted to its reactive second state as it passes through a half-cell and then is fully, or nearly fully, used and returned to its first state as it passes through the reaction chamber. Elastic turbulence can assist this by enhancing mass transport of the redox mediator to and from an electrode, enhancing mixing of the gas with the redox mediator, enhancing mass transport of the gas and redox mediator to and from any catalyst, and enhancing mass transport of reaction products away from any catalyst.

However, it may be that electrochemical reaction of the redox mediator in the half-cell is sufficiently fast that elastic turbulence is used in the reaction chamber but is unnecessary in the half-cell. It is also possible that the system is designed to limit reaction of redox mediator to its second state as the liquid flow carries it through the half-cell in order that the amount of redox mediator entering the reaction chamber is not greater than the amount which can be converted back to its first state as it passes through the reaction chamber.

The electrochemical half-cell is, by definition, one half of an electrochemical cell in which each half has an electrode. The two half-cells may be separated by a separator restricting flow between the half-cells while allowing passage of ions which are required to move from one half-cell to the other. A separator may be a membrane which has selective permeability for anions or for cations.

One possibility is that one half-cell is connected with a reaction chamber and a pump as stated above, while the other half-cell is connected and operated in some other way. For instance, the second half-cell may carry out an electrochemical reaction without a circulating redox mediator or the overall process may be such that redox mediator passing through the second half-cell takes part in a chemical reaction which will not have a gas as reactant.

### BRIEF DESCRIPTION OF THE DRAWINGS

Many of the drawings are diagrammatic and are intended to show the positions of component parts in relation to each other. Thin components such as membranes are shown with exaggerated thickness to make them and their positions more readily seen in these drawings.

FIG. 1 is a plot of experimental results showing onset of elastic turbulence.

FIG. 2 is a perspective view of a flow guide.

FIG. 3 is an enlarged top view of a portion of the flow guide.

FIG. 4 is a diagram of apparatus for observing elastic turbulence by means of birefringence.

FIG. 5 shows, in greyscale, pictures obtained with the apparatus of FIG. 4.

FIG. 6 is a schematic diagram showing component parts of an electrolytic cell and associated equipment for converting hydrogen sulfide to sulfur and hydrogen.

FIG. 7 is a schematic diagram showing component parts of another electrolytic cell and associated equipment for converting hydrogen sulfide to sulfur and hydrogen.

FIG. 8 an enlarged top view of a portion of a flow guide with different shapes of pillars.

FIG. 9 is a schematic diagram showing component parts of an electrolytic cell and associated equipment for converting hydrogen sulfide and carbon dioxide to sulfur and carbon monoxide.

FIG. 10 is a schematic diagram showing component parts of an electrolytic cell and associated equipment for converting nitrogen to ammonia.

FIG. 11 is a schematic diagram showing component parts of an electrolytic cell and associated equipment for converting carbon dioxide to formate.

FIG. 12 is a diagrammatic view of apparatus to determine operating parameters for an electrochemical half-cell.

FIGS. 13 and 14 show experimental results obtained with one example of such apparatus.

### DETAILED DESCRIPTION

This detailed description shows various embodiments of the present disclosure and possibilities which may be used. It should be appreciated that features or possibilities described in combination may, where it is practical to do so, be used separately. Also, features or possibilities described in any embodiment may be used in any other embodiment, in so far as it is possible to do so.

The present disclosure uses the phenomenon of elastic turbulence. It is of course well known that Newtonian liquids such as pure water can undergo either laminar flow or turbulent flow. Such turbulent flow may be referred to as inertial turbulence. Conditions for laminar flow and inertial turbulent flow are often expressed by Reynolds number which is a ratio of inertial to viscous forces within a liquid. Reynolds number has no dimensions because it is a ratio. At Reynolds number above about 2000 there is inertial turbulent flow. At Reynolds number below about 1500, flow of a Newtonian liquid is laminar. Flow paths within porous materials often have small dimensions and rapid flow rates through such materials are not practical, with the consequence that it is not a practical possibility for flows through porous materials to undergo inertial turbulence.

Elastic turbulence is different from inertial turbulence. It is a physical phenomenon discovered at the end of the twentieth century. It has been observed at low flow speeds where Reynolds number is low and a Newtonian liquid would be in a state of laminar flow. Some early observations of elastic turbulence used the older term “elastic instability”. However, that term is more general and includes other forms of instability in flow. Literature documents relating to elastic turbulence include a detailed discussion by Steinberg, V. (2021), “Elastic Turbulence: An Experimental View on Inertialess Random Flow”, Annual Review of Fluid Mechanics, 53, 27-58.

The phenomenon of elastic turbulence of a liquid requires: a solute which has elastic properties, enabling the liquid solution to display elastic turbulence; a flow path for the liquid which compels a succession of changes in its direction of flow, and pumping the liquid along the flow path at a sufficient velocity. A succession of changes in direction may be continuous curvature as in concentric or helical flow or may alternate between turning to the right and to the left.

Elastic turbulence occurs in solutions containing a solute which has a flexible structure. One category of material which is able to undergo elastic deformation and enable a solution to display elastic turbulence is a polymer containing long flexible linear chains. The number of monomer units in the polymer may be at least 5000 and may be considerably more such as at least 25,000. The monomer units may be present in linear chains of at least 1000 monomer units which may each be connected one to the next by a single covalent bond, so that one monomer unit can rotate relative to adjoining monomer units. Individual linear chains may be longer and a polymer may contain a linear chain of at least 5000 or even at least 10,000 monomer units. A polymer chain may contain only one kind of monomer or the chain may be a copolymer of more than one monomer, for instance a block copolymer which is linear. A polymer may also include side chains attached to a long chain of monomer units which are connected together by single covalent bonds. If a chain contains units which are themselves an oligomer, as in a block copolymer for instance, the oligomeric units may rotate relative to one another more freely than monomer residues within an oligomeric unit. A polymer may include some chain branching, for instance, at branch points where three or more linear chains, each of at least 1000 monomer units, are connected together. When using a long chain polymer to enable elastic turbulence to occur, it is desirable to include a biocide to protect the long chain linear polymer from biodegradation.

The flexibility of the polymer chains enables the polymer molecules to become entangled. The flexibility of polymer chains can be described by means of a mathematical model. The freely jointed chain model is commonly used, and the flexibility of a particular polymer can be indicated by parameters of an equivalent freely jointed chain (itself a mathematical model). A description of this approach is provided by Chapter 2 of “Polymer Physics” by Rubinstein and Colby, 2003, Oxford University Press. An equivalent freely jointed chain has the same mean-square end-to-end distance and the same maximum end-to-end distance as the actual polymer but is considered to consist of so-called Kuhn monomers which are freely rotatable relative to each other. These model monomers have a length, termed the Kuhn length, and a molar mass.

Polymers to enable elastic turbulence may contain at least one flexible polymer chain with length and composition represented by at least 5000 Kuhn monomers having a Kuhn length not more than 100 Angstroms (10 nm) and possibly not more than 50 Angstroms. If a polymer is a single unbranched chain, its length and composition may correspond to at least 20,000 Kuhn monomers and possibly at least 50,000 Kuhn monomers.

The mean molecular weight of the polymer may be at least one Mega Dalton i.e. at least 10⁶ Daltons, possibly at least 10 Mega Daltons or more. The concentration of such long chain/high molecular weight polymer included in a solution for enabling elastic turbulence to occur may be under 5% by weight, for instance in a range from 0.05% or 0.1% up to 1% or 2% by weight.

Elastic turbulence has been observed with several different long chain polymers in solution. One such polymer is polyacrylamide, which may be hydrolyzed or partially hydrolyzed. Experimental evidence for elastic turbulence in a solution of high molecular weight polyacrylamide was given by Groisman, A., Steinberg, V., “Elastic turbulence in a polymer solution flow”, Nature 405, 53-55 (2000). Other instances of long chain polymers reported to give rise to elastic turbulence include polyisobutylene of molecular weight 4 to 6 Megadaltons dissolved in an organic solvent (Dris and Shaqfeh, “Experimental and theoretical observations of elastic instabilities in eccentric cylinder flows: local versus global instability”, Journal of Non-Newtonian Fluid Mechanics, Vol 80, Pages 1 to 58 (1998)), polystyrene of molecular weight 18 Megadaltons in an organic solvent (Magda and Larson, “A transition occurring in ideal elastic liquids during shear flow”, Journal of Non-Newtonian Fluid Mechanics, Vol 30, Pages 1-19 (1988)) and polyethylene oxide of molecular weight 4 MegaDaltons in an aqueous solution (Davoodi et al., “Secondary flows due to finite aspect ratio in inertialess viscoelastic Taylor-Couette flow”, Journal of Fluid Mechanics, Vol 857, pages 823-850 (2018)). Kuhn lengths for polystyrene and polyethylene oxide have been reported as 18 Angstroms and 11 Angstroms (Rubinstein and Colby (2003), “Polymer Physics”, Page 53). Kuhn length for polyacrylamides has been reported as 15 to 25 Angstroms (Fetters, Lohse and Colby, “Chain Dimensions and Entanglement Spacings” in Physical Properties of Polymers Handbook, Springer, 2007; pages 447-454).

Long chain partially hydrolyzed polyacrylamide linear polymers with a molecular weight of more than 1 MegaDalton are available from SNF Floerger, whose headquarters are in Andrézieux, France.

Another category of material able to undergo elastic deformation and enable a solution to display elastic turbulence is a viscoelastic surfactant which forms worm-like micelles in solution. There is extensive scientific literature concerning surfactants which form worm-like micelles, their properties and applications. One review is Yang “Viscoelastic wormlike micelles and their applications” Current Opinion in Colloid & Interface Science, Volume 7, pages 276-281 (2002). Discussions of properties include Raghavan and Kaler “Highly Viscoelastic Wormlike Micellar Solutions Formed by Cationic Surfactants with Long Unsaturated Tails” Langmuir, Vol 17, Pages 300-306 (2001) and Beaumont et al, “Turbulent flows in highly elastic wormlike micelles”, Soft Matter, Volume 9, Page 735-749 (2013). An example, using cetyl trimethyl bromide as the surfactant, is mentioned by Fardin et al., “Elastic Turbulence in Shear Banding Wormlike Micelles” Physical Review Letters, 104, 178303 (2010).

When a solution contains a substance able to cause elastic turbulence, the phenomenon of elastic turbulence occurs if the solution is flowing at a sufficient flow velocity (which may be a low velocity) and the path of flow causes the streamlines of the flow to curve. Consequently, one known possibility for a flow path which induces elastic turbulence is a serpentine channel. Another possibility is a flow path with obstructions which compel the streamlines of flow to change direction. Such obstructions may be manufactured and arranged in a pattern so as to compel flow around the obstructions to change direction.

A porous material can also provide a flow path which causes a succession of changes of direction. Changes in the directions of pores and connections between pores can compel changes of flow direction. A porous material may be fibrous and the openings between the fibers will provide flow paths with a succession of changes of direction.

The ability of a fluid composition to display elastic turbulence can be shown experimentally using a laboratory rheometer. In a cone and plate rheometer cell, the onset of elastic instability with application of increasing shear is observed as an apparent increase in viscosity at a particular shear rate associated with an abrupt increase in the noise in the measured torque signal. This has been described by D. O. Olagunju, “Instabilities and bifurcations of von Karman similarity solutions in swirling viscoelastic flow” in Z Angew Math Phys, 46 (1995) 224-238 and also by E. Tran, A. Clarke, “The relaxation time of entangled HPAM solutions in flow”, Journal of Non-Newtonian Fluid Mechanics, 311 (2023) 104954. The apparent increase in viscosity can be seen as a change in the slope (sometimes referred to as an uptick) in the plot of viscosity against shear rate.

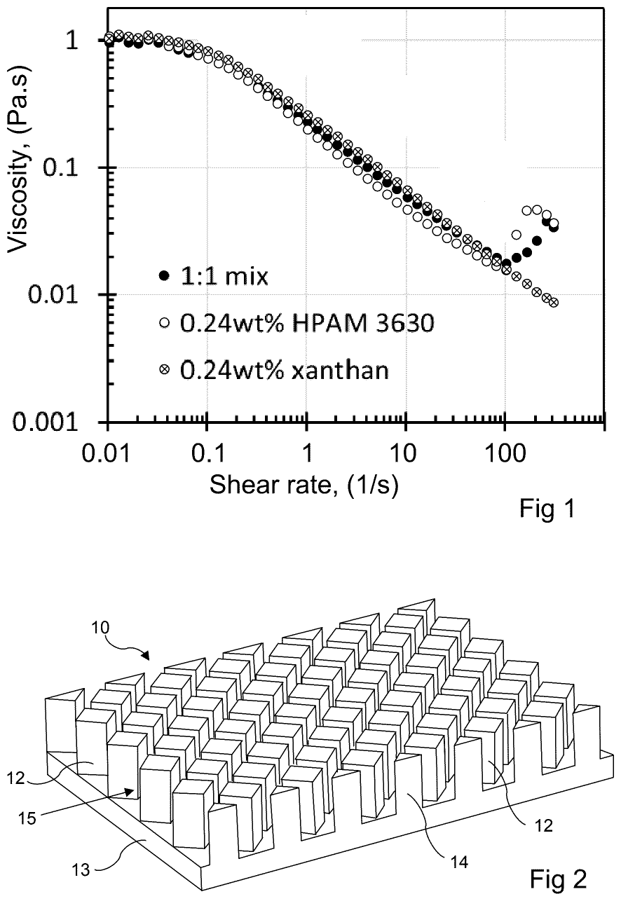

FIG. 1 shows results from experimental tests carried out with a laboratory rheometer operated to take measurements at increasing steps in shear rate and then at decreasing steps. It is a plot of dynamic viscosity against increasing shear rate for three aqueous solutions containing 0.456 wt % sodium chloride, a small percentage of a polymer and a few drops of a biocide consisting of isopropanol and thiourea. In one of these aqueous solutions (points shown as open circles in FIG. 1) the polymer was 0.24 wt % of Flopaam 3630 from SNF Floerger which is linear polyacrylamide with a mean molecular weight of 18 to 20 MegaDaltons. In a second of these solutions (points shown as circles containing a cross) the polymer was 0.24 wt % xanthan. In the third of these solutions (points shown as filled circles) the polymer was 0.12 wt % Flopaam 3060 and 0.12 wt % xanthan, i.e. a 1:1 mix. The solutions containing polyacrylamide, either alone or in mixture with xanthan, showed change in slope of the plotted curve, seen at approximately 150s⁻¹. This indicated the onset of elastic turbulence with increasing shear rate. The solution containing xanthan had no such change of slope, indicating that this more rigid polymer did not enable elastic turbulence to occur.

A similar experiment used a solution containing 0.2 wt % of Flopaam 6040, also from SNF Floerger, with a mean molecular weight between 25 and 30 MegaDaltons. Here too the onset of elastic turbulence with increasing shear rate was seen as a change in slope of the plotted curve at approximately 150 s⁻¹ indicating the onset of elastic turbulence. (Shear rates for the onset of elastic turbulence in electrochemical half-cells may be lower).

FIGS. 2 to 5 relate to experimental demonstrations of elastic turbulence in aqueous solutions of viscoelastic surfactants and also in aqueous solutions of a flexible polymer.

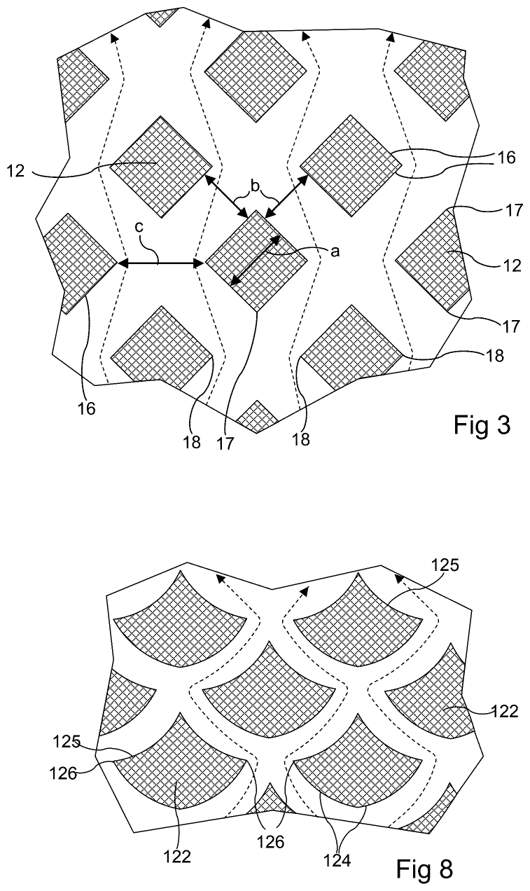

FIG. 2 shows a flow guide 10 used in these experiments. It has a regularly spaced array of pillars 12 of square cross section integral with a base 13. Two edges of the array are completed with pillars 14 which have a triangular cross section. FIG. 3 is an enlarged top view of a portion of the flow guide. As shown, the pillars 12 each have a square cross section with flat faces 16 meeting at corner edges 17 and 18. The width of a flat face 16 is indicated as “a” in FIG. 3 and the spacing between the faces 16 of adjacent pillars is indicated as “b”. The width of the gap between two confronting edges 18 is of course given by Pythagoras theorem as √(2b²). Each pillar 12 is positioned so that the diagonal across the square cross section between corner edges 17 is aligned with the overall direction of flow. As indicated by broken lines, liquid flows through the gaps between confronting edges 18 of adjacent pillars 12 but is then compelled to turn by pillars downstream. Thus, the array of pillars 12 obstructs straight line through flow of liquid, causing the streamlines of the flow to change direction repeatedly.

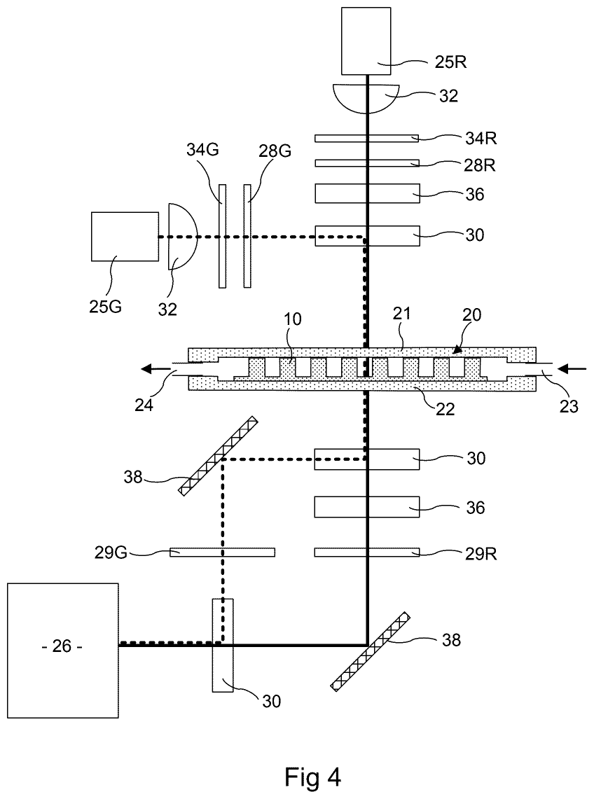

The flow guide 10 is made of transparent polymer and is located within a chamber 20 which is shown in cross section in FIG. 4. The chamber 20 is formed by two blocks of transparent polymer, 21, 22 held together by bolts which are not shown. The flow guide 10 is in a cavity between the two blocks. There is a liquid inlet 23 to the cavity and a liquid outlet 24. When liquid is pumped through the chamber 20, the liquid enters the flow guide 10 at the end indicated 15 in FIG. 2 and then flows through the gaps between the pillars 12. The repeated changes in direction can cause elastic turbulence to occur, if the liquid includes a substance able to display elastic turbulence and the flow velocity is sufficient.

The occurrence of elastic turbulence was observed using a technique utilizing the phenomenon of birefringence. The apparatus is shown in FIG. 4. It has some similarity to apparatus described by Moss GR and Rothstein JP in “Flow of wormlike micelle solutions through a periodic array of cylinders”, Journal of Non-Newtonian Fluid Mechanics, Vol 165, pages 1-13, 2010.

Beams from a red LED light 25R and a green LED light 25G are directed along paths, respectively shown as a solid line and as a broken line, towards a video camera 26. The chamber 20 is positioned between linear polarizing filters 28R, 29R set with their polarization directions at right angles (i.e. crossed) and between linear polarizing filters 28G, 29G which are also set with their polarization directions at right angles to each other. Consequently, no light can reach the video camera 26 unless birefringence in the chamber 20 alters the angle of polarization of light as it passes through the chamber. The filters 28R and 28G are set with their polarization directions at right angles to each other, so that the planes of polarization of the red and green light entering the chamber 16 are at right angles to each other. Dichroic mirrors 30 which pass the red beam and reflect the green beam are used to merge the red and green beams, then to separate them after they have passed through chamber 20, and subsequently to reunite them before they arrive at the camera 26.

Other parts of the apparatus are mirrors 38, lenses 32, red and green bandpass filters 34G and 34R and dichroic mirrors 36 which are set with a 90° difference in rotation with respect to the red beam path to cancel rotation of polarization induced due to Fresnel refraction. Such dichroic mirrors were not needed for the green beam because its polarization is such that no rotation of polarization was induced.

Wormlike micelles formed by viscoelastic surfactants are birefringent. Consequently, when these molecules become aligned by liquid flow within the chamber 20 and are illuminated with polarized red and green light, they can change the plane of polarization of the light thereby allowing some of this light to pass through the filters 29R and 29G to the camera, although this will not occur if the alignment of the micelles coincides with the plane of polarization of the light. Providing two light beams with different planes of polarization as they enter the chamber 20 addresses this issue: if micelles happen to be aligned with the red polarization, they will not be aligned with the green polarization and vice versa. Hence the apparatus is sensitive to polarization alignment in any direction.

When there is flow of a liquid containing wormlike micelles through the chamber, these micelles become aligned through extensional flow as the liquid flows around the pillars 12, 14 of the flow guide 10, and the birefringence from the aligned micelles can be seen as red or green color in pictures or video recorded by the camera 26.

A first experiment was carried out using a solution similar to one mentioned by Moss and Rothstein in the paper above. This solution contained 100 mM (approx. 4 wt %) of the viscoelastic cationic surfactant cetylpyridinium chloride and 50 mM (approx. 0.8 wt %) of sodium salicylate dissolved in a brine of 100 mM (approx. 0.6 wt %) sodium chloride in distilled water.

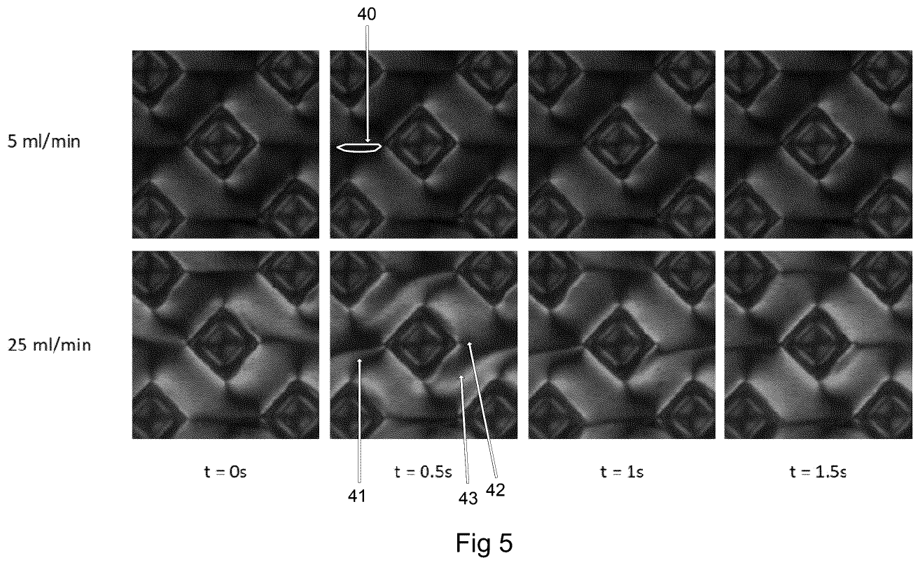

The viscoelastic solution was pumped through the chamber 20 at a low flow rate of 5 ml per minute. The camera 26 recorded video at twenty frames per second for a period of 5 seconds and the recording showed that the pattern of flow around the pillars of the flow guide remained constant. Four pictures from that video recording, at half second intervals, are shown in grayscale as the top row in FIG. 5 and it can be seen that there is negligible change from one picture to the next. The original-colored pictures showed a line of red color extending in the flow direction from the downstream corner of each pillar. A white outline has been drawn around one of these indicated 40 in one picture. These lines of red color remained at the same intensity and in the same position throughout the video recording. The flow rate was then increased to 25 ml/min and video was again recorded for 5 seconds. This video recording of flow at 25 ml/min was very different from that at 5 ml/min. It showed constant movement. Patches of color, which is where extensional flow was aligning micelles, were moving from one position to another and varying in intensity. Four pictures from the video with 25 ml/min flow rate are reproduced in greyscale as the bottom row of FIG. 5. There are several changes from each picture to the next. For instance, arrow 41 points to a patch of red color which was present in one picture but absent from the preceding picture and diminished in the two subsequent pictures. At position 42 there was an area of red color which was not present in the preceding picture and again diminished in the next two pictures. The second picture in the lower row also shows an intense green area 43, which was not present in the first picture, and which largely disappeared in the third picture. Thus, it could be seen that flow at 5 ml/min was laminar but at 25 ml/min the flow had become turbulent.

Similar experiments were carried out with a solution containing partially hydrolyzed polyacrylamide of average molecular weight 18 MDa (HPAM) to enable the display of elastic turbulence and xanthan as an additional thickening agent, and with a comparative solution containing only xanthan (which is too rigid to cause elastic turbulence, as mentioned above). These polymers do not form micelles but do cause birefringence when aligned. Flow rates and observations are given in the following table which also includes the comments from the above experiment with viscoelastic surfactant.

| Solutes | Flow rate | Comments concerning pictures |
|---|---|---|
| 4 wt % cetyl pyridinium | 5 ml/min | Red lines extending downstream from pillars do |
| chloride | | not change position. No changes in overall |
| 0.8 wt % sodium | | appearance |
| salicylate and | 25 ml/min | Red lines extending from pillars change angle |
| 0.6 wt % sodium | | relative to flow direction and change intensity. |
| chloride | | Green areas appear, change position and |
| | | disappear. |
| 0.25 wt % HPAM and | 5 ml/min | Red lines extending downstream from pillars do |
| 0.25 wt % xanthan | | not change position. Green areas do not change. |
| | 15 ml/min, | Movement of red areas extending downstream |
| | and 30 ml/min | from pillars, prominent green areas appear and |
| | | change position |
| 0.5 wt % xanthan | 5 ml/min, | Red and green areas do not change position at |
| | 30 ml/min and | any flow rate |
| | 40 ml/min | |
| 0.25 wt % xanthan | 30 ml/min | Red and green areas do not change position |
| 0.12 wt % HPAM, | 5 ml/min | Red and green areas do not change position |
| 0.12 wt % xanthan, and | 45 ml/min | Red and green areas change in shape and position |
| 0.465 wt % NaCl | | |

It is apparent from these comments that the solution containing HPAM and xanthan displayed elastic turbulence at 15 ml/min and above, but solutions containing xanthan without HPAM did not display elastic turbulence even at 30 ml/min.

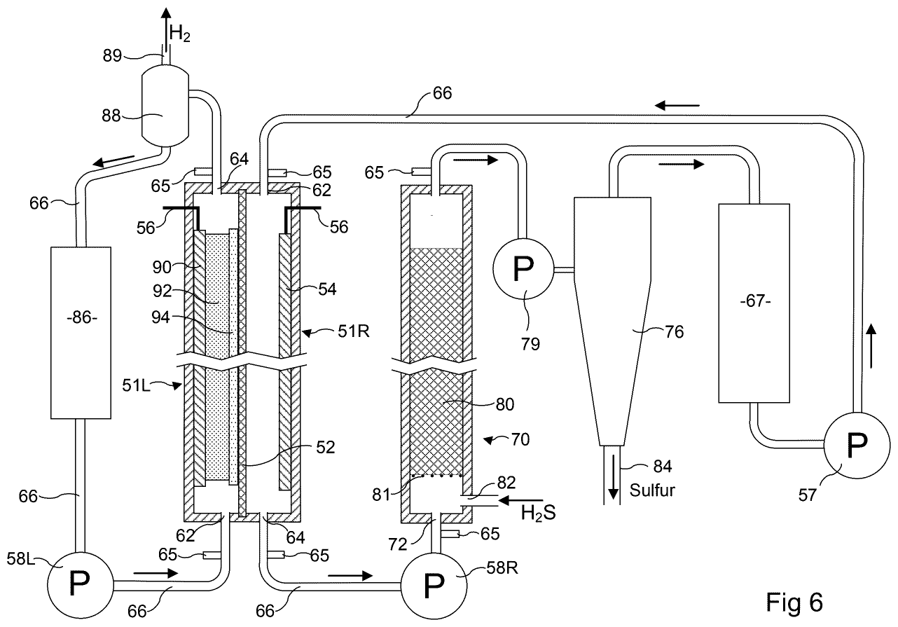

FIG. 6 shows a system for the conversion of hydrogen sulfide to hydrogen and elemental sulfur, using a redox mediator in a similar manner to that disclosed by Zijin Wang et al. in “Hydrogen sulfide splitting into hydrogen and sulfur through off-field electrocatalysis” Environmental Science and Technology, Vol 58, Page 10515 (2024). In accordance with the present disclosure, the phenomenon of elastic turbulence is also used.

The apparatus of the system includes an electrochemical cell with two half-cells 51L and 51R separated by a selectively permeable membrane 52 which may be an ion exchange membrane. The half-cell 51R and parts of the system connected to it convert hydrogen sulfide into sulfur and hydrogen ions. There is a flow of hydrogen ions through the membrane 52 and in the half-cell 51L hydrogen ions are converted to hydrogen gas.

The half-cell 51R has a positive electrode 54. The half-cell 51L has an assembly, described below, which is the negative electrode. Electrical connections to these electrodes are indicated at 56. Each half-cell has an inlet 62 and an outlet 64. Pressure sensors 65 are fitted near each inlet 62 and outlet 64.

The half-cell 51R is connected by piping 66 in a flow circuit running from a supply tank 67 through pump 57 to the inlet 62 of the half-cell 51R, then from the outlet 64 of half-cell 51R through pump 58R to the inlet 72 of a reaction chamber 70, whose outlet 74 is connected to a hydrocyclone 76. The upper outlet of the hydrocyclone is connected to the return flow inlet at the top of the supply tank 57. Liquid from the half-cell 51R is pumped around the flow circuit by the pumps 57 and 58R and the flow from the top outlet 74 of the reaction chamber 70 is propelled rapidly into the hydrocyclone 76 by pump 79. The reaction chamber 70 contains a packing 80 of ceramic beads above a mesh indicated at 81 and it has an inlet 82 for hydrogen sulfide to enter below the mesh 81.

The liquid in the tank 67, the reaction chamber 70, the half-cell 51R, the pumps 57, 58R and 79, and the pipework 66 connecting them is an aqueous solution which is the electrolyte for the half-cell 51R. One substance dissolved in this liquid is a compound which acts as a redox mediator and another solute is a polymer or a viscoelastic surfactant which enables the solution to display elastic turbulence as it flows through the packing 80. The direction of flow of this liquid is indicated by arrows.

In operation, as the circulating liquid flows through the half-cell 51R, the redox mediator is converted from its original state to a second state by electrochemical reaction at the electrode 54. In the reaction chamber 70, reaction between the hydrogen sulfide and redox mediator converts the hydrogen sulfide to hydrogen ions and sulfur which precipitates from the circulating liquid. This reaction also returns the redox mediator to its original state. This use of a redox mediator avoids exposing the membrane 52 to hydrogen sulphide and avoids precipitation of sulphur in the half-cell 51R where it would deposit on the electrode and make the electrode ineffective. The packing 80 causes flow through the reaction chamber 70 to make many changes of direction and so to be in a state of elastic turbulence as it flows through the packing 80. This enhances mixing of the hydrogen sulfide and redox mediator so that they can react together. The elastic turbulence also keeps the precipitated sulfur particles in suspension, inhibiting them from collecting on the surfaces of the ceramic beads of the packing 80.

There are a number of possibilities for the redox mediator in the half-cell 51R. One possibility, disclosed by Zijin Wang et al in the paper mentioned above is ferrous/ferric ions. The circulating liquid may be a 0.5M solution of ferrous sulfate in 1M sulfuric acid, and the Fe2+ ions are converted to Fe3+ in the half-cell 51R. These are converted back to Fe2+ ions by reaction with hydrogen sulfide in the reaction chamber 70. The reaction is:

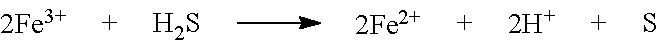

The pump 79 propels the liquid from the reaction chamber 70 rapidly into the hydrocyclone 76 where the precipitated sulfur, which has higher density than the circulating liquid, is separated and leaves the hydrocyclone through its bottom outlet 84. The circulating liquid leaves the hydrocyclone through its top outlet and flows to the return inlet of the storage tank 67.

There is a considerable body of literature concerning the design and use of hydrocyclone separators. An example of their use to perform separation operations on aqueous liquids with polyacrylamide in solution is given by Zunce Wang et al in “Characteristics Study of Hydrocyclone Used for Separating Polymer-Flood Produced-Water”, Proceedings of the Ninth (1999) International Offshore and Polar Engineering Conference, Page 226.

The half-cell 51L is connected by piping 66 in a second flow circuit running from a supply tank 86 to the pump 58L and then to the bottom inlet 62 of the half-cell 51L. Flow from the outlet 64 at the top of the half-cell 51L goes to a gas/liquid separator 88 from which liquid returns to the supply tank 86 and hydrogen gas flows upwardly through outlet 89. The liquid in this circuit is the electrolyte for the half-cell 51L and it includes a solute which enables the liquid to display elastic turbulence.

The electrode of the half-cell 51L is provided by an assembly comprising a metal sheet or grid 90 as a current carrier and porous material 92 which is also electrically conductive. The porous material 92 may be carbon felt. A layer 94 which is positioned next to the separator membrane 52 is a porous material with a catalyst for the formation of hydrogen deposited on it. There is extensive literature disclosing possible catalysts for the hydrogen evolution reaction, for example Chen et al, “Key Components and Design Strategy for a Proton Exchange Membrane Water Electrolyzer”, Small Structures, Vol 4, 2200130 (2023) and Niblett et al., “Review of next generation hydrogen production from offshore wind using water electrolysis”, Journal of Power Sources, 592, 233904 (2024).

The electrolyte liquid in the tank 86 and half-cell 51L may be 1M sulfuric acid. It includes dissolved polymer or surfactant able to cause the liquid to display elastic turbulence and this liquid is pumped with sufficient speed to induce elastic turbulence in the half-cell 51L. The elastic turbulence will be present in the porous material 92 and will also be present in the adjacent catalyst layer 94 because the porous structure of these two layers causes the flow within each of them to make repeated changes of direction and/or because the elastic turbulence in the layer 92 extends into the adjacent layer 94. The elastic turbulence dislodges hydrogen bubbles from the layers 92 and 94 before these bubbles grow to the size at which they would be dislodged by buoyancy.

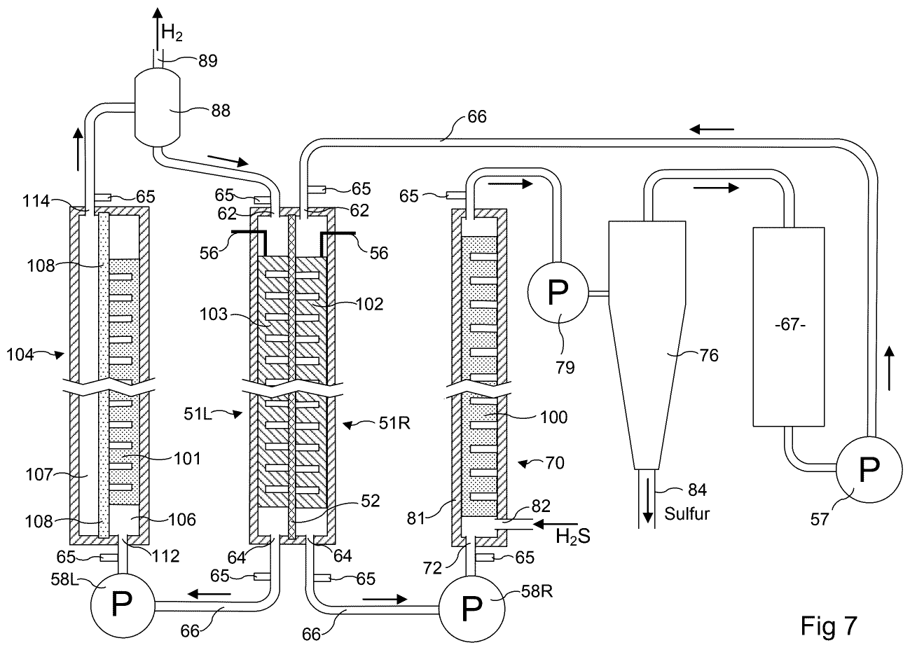

FIG. 7 shows another system for the conversion of hydrogen sulfide to hydrogen and elemental sulfur. In this system redox mediators are used in both half-cells and the flow circuits connected to them. In place of the porous packing 80 shown in FIG. 6, the reaction chamber 70 contains a flow guide 100 which has an array of spaced pillars of square cross section integral with a base as shown by the array of pillars 12 in the flow guide shown in FIG. 2. However, this flow guide 100 has a longer and wider array of pillars than are shown in FIG. 2.

There is also a flow guide 102 with an array of spaced pillars of square cross section in the half-cell 51R. This flow guide is made of an electrically conductive material, or has an electrically conductive coating, and provides the electrode of the half-cell 51R. The circulating liquid contains a polymer or viscoelastic surfactant to enable elastic turbulence to occur, and the flow speed is such that there is elastic turbulence in the reaction chamber 70 and also in the half-cell 51R.

In the half-cell 51L the electrode 103 is again an electrically conductive flow guide similar to the electrode 102. The half-cell 51L is connected in a flow circuit to a second reaction vessel 104 which has two compartments 106, 107 with a block of porous material 108 between them. This porous material 108 acts as a catalyst support and also enables elastic turbulence to occur. The inlet 112 to the reaction vessel 104 is an inlet to the compartment 106 at one side of the porous material 108 and which contains a flow guide 101 similar to the flow guide 100. The outlet 114 from the reaction vessel 104 is at the opposite side of the porous material 108.

A redox mediator and a polymer or viscoelastic surfactant able to cause elastic turbulence are both dissolved in the liquid which is circulated through the reaction chamber 104 and the half-cell 51L. In operation the pump 58L propels liquid around the flow circuit and as the liquid flows through the half-cell 51L the electrode 103 induces elastic turbulence and the redox mediator is changed from a first state to a second state. Liquid entering the compartment 106 initially flows alongside and into the porous material 108 and passes through it to reach the outlet 114. The elastic turbulence enhances mass transport of the redox mediator to and from the catalyst supported by the porous material 108, thereby reducing overpotential and also dislodges hydrogen bubbles forming at the catalyst or on the porous material 108 before they grow to a size at which buoyancy would detach them. As in FIG. 6, flow from the outlet 114 goes to gas/liquid separator 88 and the liquid from there goes to the inlet 62 at the top of the half-cell 51L.

As proposed by Zijin Wang et al in the paper mentioned above, the redox mediator in the half-cell 51R may be ferrous sulfate, and Fe2+ ions are converted to Fe3+ in the half-cell 51R and converted back to Fe2+ by reaction with hydrogen sulfide in the vessel 70. The redox mediator in the half-cell 51L and reaction chamber 104 may be a solution of vanadyl sulfate (VOSO4·xH2O) so that the reaction in the half-cell 51L is:

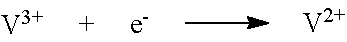

and in the reaction chamber 104 the reaction is:

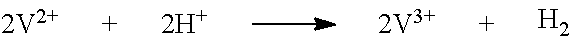

The catalyst supported by the porous material 108 in the reaction vessel 104 may be tungsten carbide.

Another possibility mentioned by Zijin Wang et al is to use 9,10-anthraquinone-2,7-disulfonic acid as redox mediator in the half-cell 51R and its connected flow circuit and a polyoxometalate H₆[CoW₁₂O₄₀] as redox mediator in the half-cell 51L and its connected flow circuit.

A flow guide to compel changes of flow direction in a reaction chamber or half-cell may have a different shape from the array of pillars shown in FIGS. 2 and 3, and in particular other shapes of pillars can be used. This is illustrated by FIG. 8 which shows pillars 122 with another possible cross section. The surfaces 124 have convex curvature and intersect concave surfaces 125 at edges 126. Liquid flows through the gaps between edges 126 as shown by the broken lines and is compelled by the arrangement of pillars 122 to change direction as it does so.

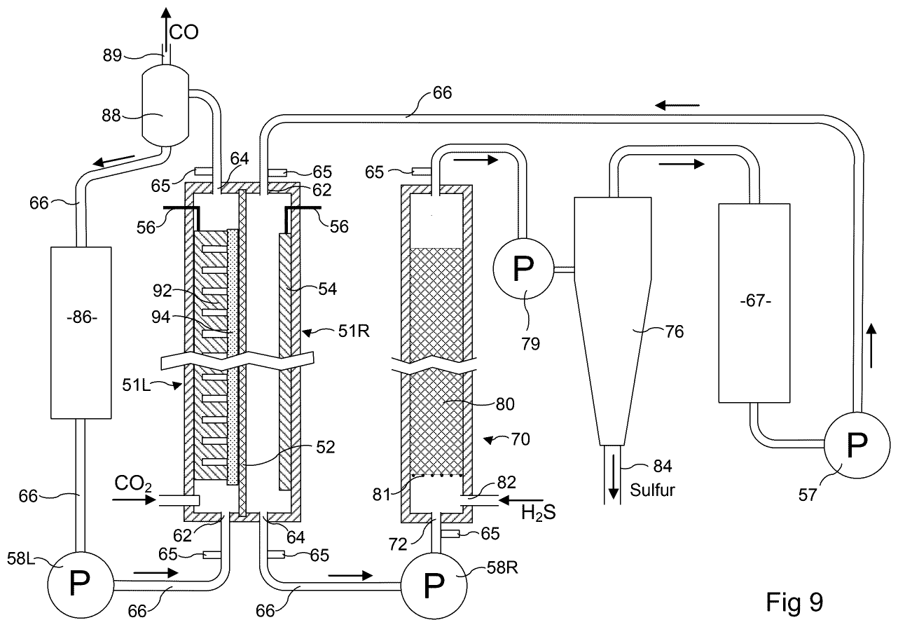

FIG. 9 shows a system which converts hydrogen sulfide to sulfur as in FIG. 6 but also converts carbon dioxide to carbon monoxide which can be used to manufacture other carbon-containing products. The electrochemistry may be as proposed by Zhang et al in “High yield of CO and synchronous S recovery from the conversion of CO₂ and H₂S in natural gas based on a novel electrochemical reactor”, Environmental Science and Technology, Vol 55, Page 14854 (2021).

The half-cell 51R and the flow circuit connected to it are the same as in FIG. 6. The liquid in this flow circuit is 0.5M potassium iodide solution acidified to pH 1 and containing a dissolved polymer or surfactant which enables the liquid to display elastic turbulence. The iodide is the redox mediator so that the electrochemical reaction in the half-cell 51R is:

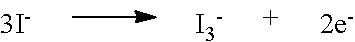

The reaction in the reaction chamber 70 is:

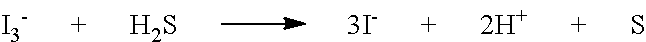

The half-cell 51L has an inlet for carbon dioxide and contains a flow guide which has an array of spaced pillars 12 of square cross section integral with a base as in the flow guides shown in FIGS. 2 and 3 but with a longer and wider array of pillars than are shown in FIG. 2. It is made of an electrically conductive material or has an electrically conductive surface coating so that it also acts as the electrode of the half-cell. Next to the flow guide is a porous layer formed of carbon fibers supporting cobalt phthalocyanine as catalyst for the electrochemical conversion of carbon dioxide to carbon monoxide in a reaction:

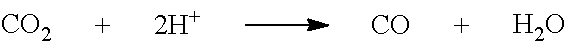

In operation, the pump 58L circulates the liquid of the half-cell 51L at a speed where the liquid is in a state of laminar flow in the piping 66 but within the half-cell 51L, the pillars of the flow guide 100 compel the flow to curve and make changes of direction repeatedly, as was shown by broken lines in FIG. 3, so that elastic turbulence is caused in the liquid as it flows through the half-cell, thereby enhancing mixing with the carbon dioxide entering at and also enhancing mass transport of reacting species to and from the cobalt phthalocyanine catalyst. The elastic turbulence in the half-cell 51L also dislodges carbon monoxide bubbles from catalyst layer before they have grown to a size at which their buoyancy would detach them. Carbon monoxide is separated from the circulating liquid at the separator 88.

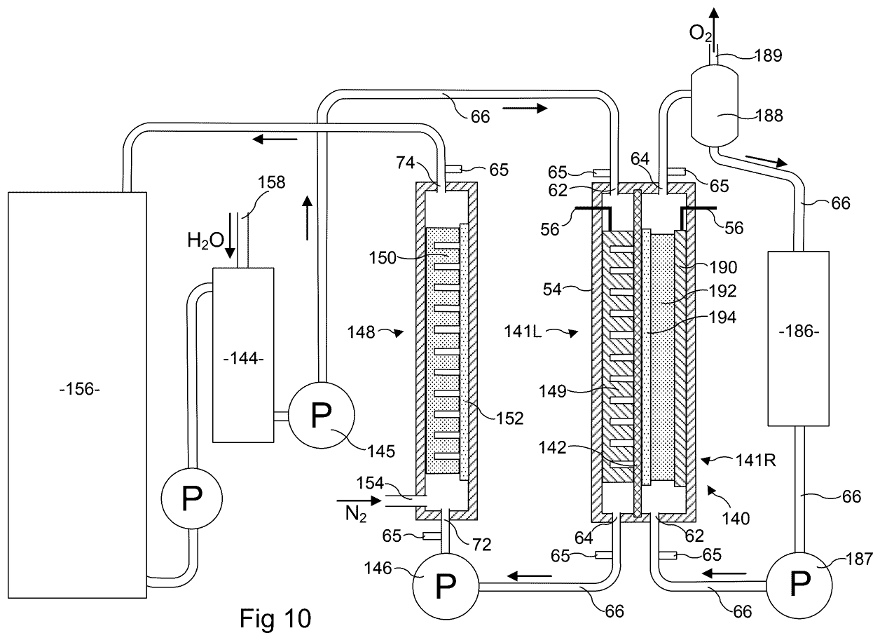

FIG. 10 shows a system for the conversion of nitrogen to ammonia and ammonium compounds, using a redox mediator as described by Xun Wang et al in “Redox-mediated ambient electrolytic nitrogen reduction for hydrazine and ammonia generation”, Angew. Chem. Int. Ed., Vol 60, Pages 18721-18727 (2021). In accordance with the present disclosure, the phenomenon of elastic turbulence is also used.

The redox mediator is a water-soluble polyoxometalate. A polyoxometalate has been defined as a polyatomic ion (or a salt thereof) containing three or more transition metal oxyanions linked together by shared oxygen atoms to form a closed 3-dimensional framework. The polyoxometalate may be that used by Xun Wang et al. which had formula Li₆P₂W₁₈O₆₂·28H₂O. The described method for preparation, on a laboratory scale, was as follows: Lithium tungstate (38.2 g, 145.9 mmol) was dissolved in boiling deionized water (60.0 mL) to obtain a white color slurry. Concentrated phosphoric acid (85%, 80.0 g, 816.4 mmol) was added dropwise (one drop per second) to the slurry at refluxing temperature (ca. 120° C.) by dropping funnel. Refluxing was maintained overnight. Then, it was cooled down to 60° C. and lithium chloride (50.0 g, 1179.5 mmol) was added portion-wise over a period of 10 minutes. A pale-yellow precipitate was formed. The pale-yellow turbid solution was refluxed overnight. The precipitate was then filtered using vacuum and dried for 1 hour. After that, the precipitate was dissolved in a minimal amount of methanol (ca. 70 mL) at room temperature. The insoluble solid was filtered off, some of the methanol was removed by rotary evaporation and the remaining solution was kept at 4° C. for 3-4 days, during which time the polyoxometalate crystallized from the solution.

As shown in FIG. 10, the system comprises an electrochemical cell 140 with half-cells 141L and 141R separated by an ion exchange membrane 142. Each half-cell has an inlet 62 and an outlet 64. Pressure sensors 65 are fitted near each inlet 62 and outlet 64. The half-cell 141L is connected by piping 66 in a flow circuit which initially runs from a supply tank 144 through pump 145 to the inlet 62 of the half-cell 141L, then from the outlet 64 of half-cell 141L through pump 146 to the inlet 72 of a reaction chamber 148. The half-cell 141R includes a flow guide 149 with pillars of square cross section as shown in FIGS. 2 and 3. This flow guide is made of electrically conductive material or has an electrically conductive coating so that it provides the electrode in the half-cell. It is connected as a negative electrode. The reaction chamber 148 includes a flow guide 150 which also has pillars of square cross section as in FIGS. 2 and 3 and is positioned alongside a porous material 152 which supports a reaction catalyst. This flow guide 150 may be made of electrically non-conductive material.

The liquid in this circuit is an aqueous solution of dilute sulfuric acid, containing the polymetalate as redox mediator and also containing a high molecular weight polymer or a viscoelastic surfactant so that solution is capable of elastic turbulence. The flow guides 149 and 150 compel the flowing liquid to make frequent changes of direction and the flow rate is sufficient that this causes elastic turbulence to occur as the liquid flows through the half-cell 141L and through the reaction chamber 148. In the half-cell 141L this enhances mass transport of the polymetalate redox mediator to and from the surfaces of the conductive flow guide 149 acting as negative electrode and the redox mediator molecules become negatively charged. In the reaction chamber 148, the elastic turbulence enhances mass transport to and from the reaction catalyst carried on porous support 152.

A supply of nitrogen gas is pumped into the reaction chamber through inlet 154. The particulate catalyst on the porous support 148 enables reaction of the nitrogen gas with the charged redox mediator, converting the nitrogen to ammonium ions and returning the redox mediator to its original state. This catalyst may be iron, attached to titanium dioxide particles which are held on the porous support. The preparation of such particles, as given by Xun Wang et al. stated that FeCl₃ and TiO₂ in a 3:97 ratio by weight were dispersed in 10 times their weight of water. The mixture was stirred for 1 hour and centrifuged at 10000 rpm for 5 minutes. The solid collected by centrifuging was sintered at 600° C. The sintered catalyst was then ground to small particle size.

The polyoxymetalate ions can carry a number of electrical charges. Denoting the polyoxometalate redox mediator as POM and assuming it is charged with 18 electrons, the reactions can be written as:

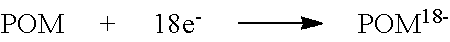

in the half-cell 141L

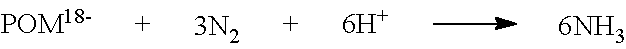

in the reaction chamber 145 and then

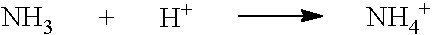

in the reaction chamber 145.

As ammonia is formed in the reaction chamber, the pH of the flowing solution rises and may exceed the pKa of ammonia in aqueous solution so that the flowing liquid contains both dissolved ammonia and ammonium ions. Flow from the outlet 74 of the reaction chamber 148 is piped to apparatus 156 which carries out the well-known ammonia stripping process. The alkaline liquid from the reaction chamber 148 is heated to its boiling point so that ammonia and some water evaporate and are collected by a condenser. The ammonia may be concentrated to become pure ammonia in further distillation stages.

After this evaporation, the residual liquid, still containing the dissolved polyoxometalate redox mediator and the polymer or viscoelastic surfactant which enables elastic turbulence, is returned from the apparatus 156 to the supply tank 144, thus completing the flow circuit. Additional water is added to the flow through an inlet 158 of the supply tank 67 so as to replace water evaporated during ammonia stripping.

Similarly to the half-cell 51L in FIG. 6, the half-cell 141R is connected by piping 66 in a second flow circuit running from a supply tank 186 to the pump 187 and then to the bottom inlet 62 of the half-cell 141R. Flow from the outlet 64 at the top of the half-cell 141R goes to a gas/liquid separator 188 from which liquid returns to the supply tank 186 and oxygen gas flows upwardly through outlet 189. The liquid in this circuit is the electrolyte for the half-cell 141R and it contains a solute which enables the liquid to display elastic turbulence.

The electrode of the half-cell 141R is provided by an assembly comprising a metal sheet or grid 190 as a current carrier and porous material 192 which is also electrically conductive. The porous material 192 may be carbon felt. A layer 194 which is positioned next to the separator membrane 142 is a porous material with a catalyst for the formation of oxygen deposited on it. A number of catalysts for the oxygen evolution reaction are known, as described in the Chen et al paper mentioned above. The liquid in the tank 186 and half-cell 141R may be dilute sulfuric acid. It contains dissolved polymer or viscoelastic surfactant able to cause the liquid to display elastic turbulence and this liquid is pumped with sufficient speed to induce elastic turbulence in the half-cell 141R. The elastic turbulence will be present in the porous material 192 and will also be present in the adjacent catalyst layer 194 because the porous structure of these two layers causes the flow within each of them to make repeated changes of direction and/or because the elastic turbulence in the layer 192 extends into the adjacent layer 194. The elastic turbulence dislodges oxygen bubbles from the layers 192 and 194 before these bubbles grow to the size at which they would be dislodged by buoyancy.

As mentioned in a number of scientific articles, the electrochemical reduction of carbon dioxide can lead to a number of products, and in some cases a mixture of products. The product which is obtained is dependent on the catalyst which is chosen for the electrochemical cell where reduction occurs, and possible products include carbon monoxide, methanol, ethanol, formic acid, formaldehyde and ethylene.

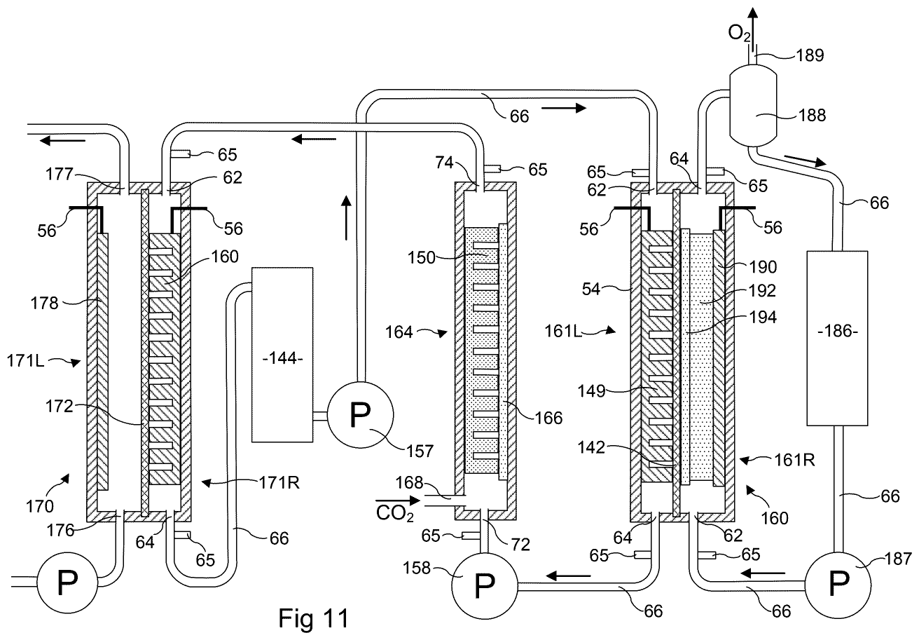

FIG. 11 shows a system for the reduction of carbon dioxide to formate, with electrochemistry based on that described in Potter et al, “Electrochemically decoupled reduction of CO₂ to formate over a dispersed heterogeneous bismuth catalyst enabled via redox mediators”, EES Catalysis, Vol 2, Page 379 (2024). The electrochemical cell 160 and the reaction chamber 164 have very similar structure to the cell 140 and reaction chamber 148 shown in FIG. 10 and items which are the same are indicated with the same numerals. The redox mediator and electrochemistry of the half-cell 161R are the same as described for FIG. 10.

The liquid circulating through the half-cell 161L and the reaction chamber 164 is an aqueous solution containing a high molecular weight polymer to enable elastic turbulence to occur, and the potassium salt of chromium propanediamine tetraacetate as redox mediator. The reaction chamber 164 contains bismuth powder as catalyst on porous support 166.

In the half-cell 161L the chromium complex is reduced from Cr(III) to Cr(II) at the electrically conductive flow guide 149. Carbon dioxide is supplied to the reaction chamber 164 through inlet 168 and it reacts with the chromium complex at the bismuth catalyst to become formate ions, while the chromium complex returns to the Cr(III) state.

Liquid from the outlet 74 of the reaction chamber 168 is piped to half-cell 171R of a second electrochemical cell 170 whose purpose is to separate the formate from the flowing liquid. In this cell the membrane 172 separating the half-cells 171R and 171L is made up of two layers. One layer is an ion exchange membrane which allows passage of anions but not cations. The other layer of the membrane is a size exclusion membrane which allows passage of small molecules but blocks passage of larger ones.

The half-cell 171R contains a flow guide which, like the flow guide 149 is electrically conductive so that it can act as an electrode and has pillars of square cross section as shown in FIGS. 2 and 3, so that liquid passing through it can be in a state of elastic turbulence. The half-cell 171L has an inlet 176 through which water or a dilute aqueous solution is supplied and an outlet 177. The electrode 178 in this half-cell is connected as a positive electrode and the conductive flow guide 160 in half-cell 171R is connected as a negative electrode.

In this electrochemical cell 170, formate ions in the liquid flowing through half-cell 171R are attracted through the two-layer membrane 172 towards the positive electrode 178 but the size exclusion layer of the membrane will not allow passage of the chromium complex, nor the high molecular weight polymer which enables elastic turbulence to occur. Thus, the formate which is formed in the reaction chamber 164 is separated from the liquid flow in which it was formed, while that liquid flow returns to the supply tank 144. Elastic turbulence in the half-cell assists mass transport of formate ions towards the membrane 172 and any reduction of the redox mediator to its Cr(II) state will not interfere with the supply of reduced redox mediator to the reaction chamber 164.

For reaction chambers and electrochemical half-cells as described above, with a polymer or surfactant present in a circulating liquid to enable elastic turbulence to occur, a flow rate which is sufficient to cause elastic turbulence to occur may be found by monitoring electric current while progressively increasing the flow rate. When elastic turbulence begins the improved mass transport to and from surfaces and consequent increase in the rate of chemical reaction will be apparent as an increase in the flow of electric current.

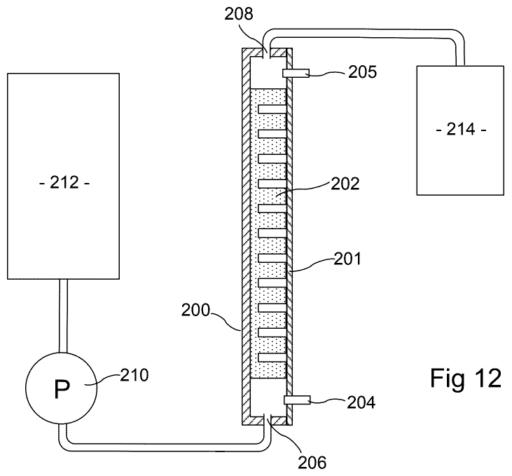

However, it is also possible to determine a suitable flow rate without operation of complete apparatus, which may be useful at a design stage. This is illustrated by FIGS. 12 to 14. As shown in FIG. 12, a structure 200 with the dimensions of a proposed reaction chamber includes a proposed flow guide 201 having the shape shown as the flow guides in several drawings including 100-102 in FIGS. 7 and 149 and 150 in FIGS. 10 and 11. No separating membrane is present. Instead, a plate 202 is fitted against the tops of the pillars of the flow guide 201. Pressure sensors 204, 205 are fitted at the inlet and outlet regions of the structure 200. The inlet 206 is connected to a pump 210 which delivers fluid from a tank 212 which is maintained at a fixed temperature. This fluid should be the same as the fluid which will flow through the proposed reaction chamber or half-cell. The outlet 208 of the structure 200 is connected to a graduated vessel 214 for measuring volume of liquid which has been pumped through the flow guide 201 in a chosen interval of time and thereby determining the flow rate.

When liquid from the tank 212 is pumped through the structure 200 containing flow guide 202 there will be a pressure drop between the inlet pressure sensor 204 and the outlet pressure sensor 205. When the flow rate is very low, the flow will be laminar, without any elastic turbulence. The minimum flow rate to cause elastic turbulence in the flow guide 201 can be found by progressively increasing the pump speed to increase the flow rate and plotting the pump speed, which increases with pressure drop, against flow rate. This plot will show a change in slope on reaching the flow rate at which elastic turbulence begins.

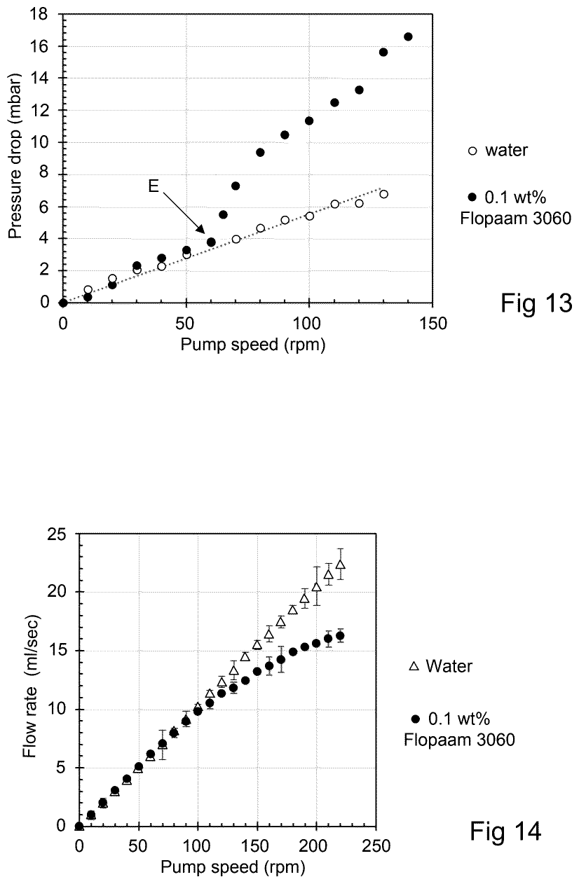

This is illustrated by the following description of experimental work with apparatus similar to that shown. The results of the experiments are shown in FIGS. 13 and 14. An initial calibration determined relationships between pump speed and flow rate. The tank was filled with water. The pump was used to propel water through the structure 200 containing flow guide 201 at progressively increasing flow rate. The pump speeds and the flow rates measured downstream of the structure 200 were recorded and are shown in FIG. 14 (triangle points). This procedure was then repeated with an aqueous solution containing 0.1 wt % of Flopaam 3630 polyacrylamide dissolved in the liquid in the tank. This gave the non-linear plot which is also shown in FIG. 14 (circular points).

FIG. 13 shows the measured flow rates plotted against pump speed. With water the plot was approximately linear (as would be expected because water is a Newtonian fluid) but with the polyacrylamide solution there was a very sharp change in the slope of the plot at the point E, indicating that the flow rate at this point was the minimum required to cause elastic turbulence with that polyacrylamide solution and apparatus.

Measurements of this kind make it possible to estimate Reynolds number for flow through a flow guide. The formula which may be used to determine Reynolds number (Re) for flow through a chamber containing obstructions so as to compel the flow streamlines to bend is:

$$Re = \frac{ρ UL}{η}$$

where ρ is density of the fluid in Kg per cubic metre,
U is the flow velocity in metres per second,
L is the width of the gaps between the obstructions in the chamber, and
η is the viscosity of the fluid in Pascal·sec.

If the flow rate is measured as volume in unit time, the formula above becomes:

$$Re = \frac{ρ QL}{η A}$$

where Q is the flow rate in cubic metres per second and A is the cross-sectional area, transverse to the overall direction of flow, through which the flow passes.

Referring to the dimensions indicated in FIG. 3, an example flow guide shown in FIGS. 7, 11 and 14, the flat faces of the pillars had a width “a” of 4 mm and the height of the pillars was 7 mm. The spacing “b” between the faces 16 of adjacent pillars was 2 mm and so the gaps between adjacent edges 18 was √8=2.83 mm. A full line of pillars transverse to the overall direction of flow contained 12 pillars with 11 gaps between edges, and so the cross section available for flow was:

$$11 \times 7 \times 2.83 {mm}^{2} = 11 \times 7 \cdot {10}^{- 3} \times 2.83 \cdot {10}^{- 3} {m}^{2} .$$

Flow rate was measured as 75 ml·sec⁻¹=7.5×10⁻⁵ m³ sec⁻¹. Density of the fluid was 1000 kg/m³; viscosity was 0.008 Pa·sec. Putting these numbers into the formula mentioned above:

$$Re = \frac{ρ QL}{η A} = \frac{100 \times 7.5 \cdot {10}^{- 5} \times 2.83 \cdot {10}^{- 3}}{8 \cdot {10}^{- 3} \times 11 \times 7 \cdot {10}^{- 3} \times 2.83 \cdot {10}^{- 3}}$$

which is Re=12.17.

Various embodiments of this disclosure have been set out above. These are intended to assist understanding of this disclosure, but not to limit it in any way. It should be appreciated that any features or possibilities described in combination may, where it is practical to do so, be used individually. Also, features or possibilities mentioned in the following claims or described in any embodiment may be used in any other embodiment, in so far as it is practical to do so and where two or more of the following claims are dependent on the same preceding claim, the reader should understand that the present disclosure includes any possible combination of any two or more or all of those dependent claims with each other and also with that preceding claim.

1. A system comprising:
a reaction chamber;
a device for supplying a reactant gas to the reaction chamber;
an electrochemical cell comprising first and second half-cells each comprising an electrode;
at least one pump, and connections between the pump, the reaction chamber and the first half-cell providing a first flow circuit for the pump to circulate a liquid through the reaction chamber, from the reaction chamber to the first half-cell, through the first half-cell and back to the reaction chamber; wherein:
the first half-cell defines a flow path to carry flow of the liquid into contact with the electrode;
the reaction chamber defines flow paths to carry flow of the liquid and flow of the gas into contact with each other in the reaction chamber;
an electrochemically reactive mediator substance is dissolved in the liquid and the mediator substance is such that when electric current is supplied to the electrode while the pump is circulating the liquid, the mediator substance is converted from a first state to a second state at the electrode;
the gas is able to undergo a reaction with the mediator substance in the reaction chamber which converts the gas to a reaction product and returns the mediator substance to the first state thereof;
and further wherein the liquid further comprises a solute enabling the liquid to display elastic turbulence; and
the flow path in the reaction chamber is configured to compel changes in the direction of liquid flow, to cause elastic turbulence of the flow of the liquid in the reaction chamber.

2. The system of claim 1, wherein the flow path in the reaction chamber extends through a bed of particulate material which compels changes in the direction of liquid flow.

3. The system of claim 2, wherein the bed of particulate material is a catalyst or supports a catalyst for the reaction of the gas with the mediator substance in the reaction chamber.

4. The system of claim 1, wherein the reaction chamber comprises a flow guide formed of solid material and defining a flow path which includes obstructions which compel changes in the direction of liquid flow.

5. The system of claim 4, wherein the flow path through the reaction chamber extends beside porous material which supports a catalyst for the reaction of the gas with the mediator substance in the reaction chamber.

6. The system of claim 1, wherein the flow path in the first half-cell is configured to compel changes in the direction of liquid flow, to cause elastic turbulence within flow of the liquid in contact with the electrode of the first half-cell.

7. The system of claim 1, wherein the solute enabling the liquid to display elastic turbulence is a viscoelastic surfactant which forms wormlike micelles.

8. The system of claim 1, wherein the solute enabling the liquid to display elastic turbulence is a linear polymer with a molecular weight of at least 10⁶ Daltons.

9. The system of claim 1, wherein the solute enabling the liquid to display elastic turbulence is a polymer comprising at least 5,000 monomer units in one or more linear polymer chains each comprising at least 1,000 monomer units, connected one to the next by a single covalent bond so that one monomer unit can rotate relative to adjoining monomer units.

10. The system of claim 9, wherein the polymer is a polyacrylamide or hydrolyzed polyacrylamide.

11. The system of claim 1, wherein the reaction in the reaction chamber is selected from the group consisting of:
conversion of hydrogen sulfide to sulfur;
conversion of nitrogen to ammonia;
conversion of hydrogen sulfide and carbon dioxide to sulfur and carbon monoxide;
conversion of carbon dioxide to any of carbon monoxide, methanol, ethanol, ethylene, formic acid or a formate; and
conversion of oxygen to water.

12. The system of claim 1, wherein the second half-cell defines a flow path to carry flow of a second liquid into contact with the electrode of the second half-cell and the system comprises:
at least one pump connected to propel a second liquid along the flow path into contact with the second electrode wherein the said flow path is configured to compel changes in the direction of liquid flow and the second liquid comprises a solute enabling the second liquid to display elastic turbulence within the second half-cell.

13. The system of claim 1, further comprising:
a second reaction chamber;
at least one further pump and connections between the further pump, the second reaction chamber and the second half-cell providing a second flow circuit for the further pump to circulate a second liquid through the second reaction chamber, from the second reaction chamber to the second half-cell, through the second half-cell and back to the second reaction chamber; wherein:
the second half-cell defines a flow path to carry flow of the liquid into contact with the electrode of the second half-cell;
a second electrochemically reactive mediator substance is dissolved in the second liquid and the second mediator substance is such that when electric current is supplied to the electrode of the second half-cell while the further pump is circulating the liquid, the mediator substance is converted from a first state to a second state at the electrode of the second half-cell, and
reaction of the mediator substance in the second reaction chamber returns the second mediator substance to the first state thereof.

14. The system of claim 13, wherein the second liquid further contains a solute enabling the second liquid to display elastic turbulence, and the flow path in the second reaction chamber is configured to compel changes in the direction of liquid flow, to cause elastic turbulence of the flow of the second liquid in the second reaction chamber.

15. The system of claim 14, wherein the flow path in the second reaction chamber extends through a bed of particulate material which compels changes in the direction of liquid flow.

16. The system of claim 13, wherein the second reaction chamber contains a flow guide formed of solid material and defining a flow path which includes obstructions which compel changes in the direction of liquid flow.

17. A method for conversion of a gas to another substance comprising:
operating a system according to claim 1, by pumping the liquid around the flow circuit, supplying the gas to an inlet of the reaction chamber and applying electrical potential to the electrodes.
